(19) United States
(12) Patent Application Publication
(10) Pub. No.: US 2025/0016578 A1
(43) Pub. Date: Jan. 9, 2025

(54) PREDICTION OF SUPERVISION FAILURES

(71) Applicant: Ademco Inc., Golden Valley, MN (US)

(72) Inventor: Nagaraj Chickmagalur Lakshminarayan, Bangalore Karnataka (IN)

(73) Assignee: Ademco Inc., Golden Valley, MN (US)

(21) Appl. No.: 18/710,067

(22) PCT Filed: May 11, 2022
(86) PCT No.: PCT/US2022/028710

§ 371 Date: May 14, 2024

(30) Foreign Application Priority Data
Nov. 15, 2021 (IN) 202141052385

(51) Int. Cl. H04W 16/22; H04W 4/38; H04W 24/08

(52) U.S. Cl. CPC H04W 16/22; H04W 4/38; H04W 24/08

(57) ABSTRACT

Disclosed herein are techniques for predicting supervision failure in a premise wireless network. A device receives, from a hub device of a premise wireless network, hub wireless communication data. The device receives, from at least one sensor device of the premise wireless network and in wireless communication via the premise wireless network with the hub device, sensor wireless communication data. The device also receives environmental data. The device applies a prediction model to the hub wireless communication data, the sensor wireless communication data, and the environmental data to determine a prediction of supervision failure between the hub device and the at least one sensor device.

### TECHNICAL FIELD

The disclosure relates to networks, for instance, networks used in home automation, comfort, and security systems.

### BACKGROUND

A home network may use a wireless network protocol to connect devices within the home. For example, a hub device may use IEEE 802.15.4 to connect to over one hundred sensor devices in a home to the hub device. The hub device may then collect sensor data collected by the sensor devices in the home. For instance, the hub device may collect door/window, or other security or home automation, sensor readings and output the door/window, or other security or home automation, sensor readings to a home security sensor or other device in the home network or, in some cases, to a remote server. In another instance, the hub device may collect temperature readings from multiple temperature sensors arranged within the home and output the temperature readings to a thermostat that controls an HVAC system using the temperature readings.

### SUMMARY

In general, this disclosure relates to systems, devices, and methods for predicting various failures amongst hub devices and/or sensor devices present on a local network. These hub devices and/or sensor devices communicate with one of the hub devices or an outside server device to transmit present data experiences by the hub device or sensor device. This data can include any one or more of hub-centric communication data, sensor-centric communication data, or environmental data. The device receiving this data (e.g., the hub device or the outside server device) can analyze this data using a particular machine-learning model to predict when a failure is potentially about to occur (e.g., a supervision loss, a battery failure, an interference issue, or a location issue). To close the feedback loop, the device may additionally receive an indication of whether the predicted failure actually occurred, automatically adjusting various aspects of the machine learning model based on the realization of the failure or the absence of the failure.

Techniques described herein may improve a performance of a network. For example, a device that performs the prediction described herein may address potential issues in a local premise network prior to the issue occurring. This may reduce the downtimes experienced when the failures ultimately occur, the time and effort to discover the failure after the occurrence of the failure, and the loss in efficiency experienced by the failures.

Furthermore, the failure experienced by sensors and hub devices in a local security network is inherent to this type of technology. Different environments may have different layouts, constructions, and network setups, meaning there may be no universal system to accurately predict or determine failures in every location. By taking environmental factors into account, the techniques described herein solve a problem inherent to this technology to adequately and accurately predict potential failures in locations that have unique factors that could possibly contribute to those failures.

One embodiment includes a method comprising a step of receiving, from a hub device of a premise wireless network, hub wireless communication data. The method further comprises a step of receiving, from at least one sensor device of the premise wireless network and in wireless communication via the premise wireless network with the hub device, sensor wireless communication data. The method also comprises a step of receiving environmental data. The method further comprises a step of applying a prediction model to the hub wireless communication data, the sensor wireless communication data, and the environmental data to determine a prediction of supervision failure between the hub device and the at least one sensor device.

In a further embodiment of the method, the hub wireless communication data comprises a collection of one or more of an operating channel number, an information channel number, a date of installation, a media access control (MAC) address, and a short address.

In one such example of this further embodiment, the collection further comprises one or more of a number of frequency agility, a number of packets received from the at least one sensor device, a supervision time of the hub device, a wake-up time of the hub device, a number of over the air network downloads (“OND”) on the at least one sensor device, a supervision loss, a superframe slotting, and an energy on each channel used by the hub device.

In a further embodiment of the method, the sensor wireless communication data comprises a collection of one or more of a battery status of the at least one sensor device, an estimated battery life of the at least one sensor device, a type of battery in the at least one sensor device, and a theoretical battery life estimation for the at least one sensor device.

In one such example of this further embodiment, the collection further comprises one or more of a number of non-time division multiple access (TDMA) protocol packets, a link quality indication (LQI) signal strength, a number of beacon loss, a number of sync loss, a number of sync commands, and energy detection around the at least one sensor device.

In a further embodiment of the method, the environmental data comprises a collection of one or more of wireless operating channel power data, a number of additional hub devices, an operating channel for each of the additional hub devices, a number of sensor devices in the at least one sensor device, a location of the at least one sensor device, an image of an environment including the hub device and the at least one sensor device, a size of a building that contains the premise wireless network, a material of one or more walls in the building, a layout plan of the building, a location of an access point for the premise wireless network, and a region of operation.

In one such example of this further embodiment, the collection further comprises one or more of a first WiFi® operating channel power at the hub device, and a second WiFi® operating channel power around the hub device.

In a further embodiment of the method, the method further comprises adjusting the prediction model based at least in part on the environmental data.

In one such example of this further embodiment, adjusting the prediction model based at least in part on the environmental data comprises analyzing one or more of a size of a building that contains the premise wireless network, a material of one or more walls in the building, a location of the at least one sensor device, a location of the hub device, a layout plan of the building, and a location of an access point for the premise wireless network to determine an environmental impact of the environmental data and adjusting one or more aspects of the prediction model based on the environmental impact.

In a further embodiment of the method, the method further comprises, after determining the prediction of the supervision failure, detecting whether the supervision failure actually occurred, and adjusting one or more aspects of the prediction model based on the prediction of the supervision failure and whether the supervision failure actually occurred.

In one such example of this further embodiment, adjusting one or more aspects of the prediction model comprises one or more of adjusting one or more weights in the prediction model and adjusting one or more thresholds in the prediction model.

In a further embodiment of the method, the prediction model comprises each of an environmental model, a sensor model, a hub model, a system model, and a final model.

In one such example of this further embodiment, applying the prediction model comprises applying the environmental model to the environmental data to determine an environment state, applying the hub model to the hub wireless communication data to determine a hub state, applying the sensor model to the sensor wireless communication data to determine a sensor state, applying the system model to the environment state, the hub state, and the sensor state to determine a system state, and applying the final model to the system state to predict the supervision failure.

In a further embodiment of the method, the supervision failure comprises one or more of a supervision loss, a battery replacement, a local interference source, an interference presence around the at least one sensor device, a sensor installation location problem, a repeater installation location problem, and a sensor location change.

In a further embodiment of the method, applying the prediction model comprises applying, by a server device, the prediction model to the hub wireless communication data, the sensor wireless communication data, and the environmental data to determine the prediction of supervision failure between the hub device and the at least one sensor device.

In a further embodiment of the method, applying the prediction model comprises applying, by the hub device, the prediction model to the hub wireless communication data, the sensor wireless communication data, and the environmental data to determine the prediction of supervision failure between the hub device and the at least one sensor device.

In a further embodiment of the method, the premise wireless network comprises a time division multiple access (TDMA) protocol-enabled wireless network.

Another embodiment includes a device comprising a storage component configured to store a prediction model. The device further comprises one or more communication units configured to receive, from a hub device of a premise wireless network, hub wireless communication data, receive, from at least one sensor device of the premise wireless network and in wireless communication via the premise wireless network with the hub device, sensor wireless communication data, and receive environmental data. The device further comprises one or more processors configured to apply the prediction model to the hub wireless communication data, the sensor wireless communication data, and the environmental data to determine a prediction of supervision failure between the hub device and the at least one sensor device.

In a further embodiment of the device, the hub wireless communication data comprises a collection of one or more of a number of frequency agility, a number of packets received from the at least one sensor device, a supervision time of the hub device, a wake-up time of the hub device, a number of over the air network downloads (“OND”) on the at least one sensor device, a supervision loss, a superframe slotting, and an energy on each channel used by the hub device.

In a further embodiment of the device, the sensor wireless communication data comprises a collection of one or more of a number of non-time division multiple access (TDMA) protocol packets, a link quality indication (LQI) signal strength, a number of beacon loss, a number of sync loss, a number of sync commands, and energy detection around the at least one sensor device.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the in present invention will hereinafter be described in conjunction with the appended drawings.

FIG. 1 is a conceptual diagram illustrating an example system for predicting a supervision failure, in accordance with some examples of this disclosure.

FIG. 2A is a conceptual block diagram illustrating an example of a home network, in accordance with some examples of this disclosure.

FIG. 2B is a conceptual block diagram illustrating a hub device in greater detail, in accordance with some examples of this disclosure.

FIG. 3 is a flow diagram illustrating a method, in accordance with some examples of this disclosure.

FIG. 4 is a flow diagram illustrating a method, in accordance with some examples of this disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Modern residential buildings or other buildings may include a central “hub” device configured to manage one or more systems within the building, such as monitoring systems, comfort systems, security systems, and/or home automation systems. The hub device can be in wireless communication with a number of other devices placed throughout the building. For example, the hub device may wirelessly receive sensor data from any number of different sensor devices, such as motion sensors, air quality and/or temperature sensors, infrared sensors, door and/or window contact sensors, switches, and/or other sensor devices. Additionally, the hub device may wirelessly transmit commands or instructions to one or more controllable sensor devices. For example, the hub device may instruct a thermostat to adjust a temperature within the building, or in another example, may command a damper to open or close an air vent.

In some applications for managing one or more systems within a building, BLUETOOTH radio communication techniques may have an advantage over other radio connection techniques such as, for example, IEEE 802.15.4 radio communication techniques. For instance, BLUETOOTH radio communications techniques may support high data rates and throughput compared to IEEE 802.15.4 radio communication techniques. For example, BLUETOOTH may have a bandwidth of greater than 500 kilobits-per-second (kbps) (e.g., 1 Mbps) and IEEE 802.15.4 may have a bandwidth of less than 500 kbps (e.g., 250 kbps). From a range perspective, BLUETOOTH radio techniques and IEEE 802.15.4 radio communication techniques may have nearly equal link budget. BLUETOOTH may have a range of greater than 80 meters (e.g., 100 meters) and IEEE 802.15.4 may have a range of less than 80 meters (e.g., 70 meters). In some examples, BLUETOOTH may have a join time (e.g., latency) of greater than 1 second (e.g., 3 seconds) and IEEE 802.15.4 may have a join time of less than 1 second (e.g., 30 milliseconds (ms)). BLUETOOTH may have a stack size of greater than 100 kb (e.g., 250) kb) and IEEE 802.15.4 may have a stack size of less than 100 kb (e.g., 28 ms). In some examples, IEEE 802.11, also referred to herein as simply “Wi-Fi™,” may offer even higher data rates than BLUETOOTH but with a higher energy cost.

As used herein, BLUETOOTH may refer to present and future versions of BLUETOOTH. Examples of BLUETOOTH include classic BLUETOOTH (e.g., Versions 1.0, 1.0B, 1.1, 1.2, 2.0, 2.1, 3.0, 4.0, 4.1, 4.2, 5, 5.1, etc.), BLUETOOTH-low energy (e.g., Versions 4.0, 4.1, 4.2, 5, 5.1, etc.), and other types of BLUETOOTH. As such, all instances of “BLUETOOTH” herein should be interpreted as including classic BLUETOOTH and/or BLUETOOTH-low energy. BLUETOOTH may operate at frequencies between 2.402 and 2.480 GHZ, 2.400 and 2.4835 GHz including a 2 MHZ wide guard band and a 3.5 MHz wide guard band, or another frequency range. In some examples, each frequency channel of the BLUETOOTH channel may have a center frequency different from a central frequency of a neighboring channel by less than 1 MHz. In some examples, each frequency channel of a wireless channel (e.g., an IEEE 802.15.4 channel) may have a center frequency different from a central frequency of a neighboring channel by greater than 1 MHZ (e.g., 2 MHZ, 5 MHZ, etc.).

Smart home devices may deploy many different wireless protocols to address the needs to the smart home. There are standards based protocols (Wi-Fi™, Zigbee™, Thread™. Zwave™, BLUETOOTH, DECT™, etc.) and proprietary, manufacture specific protocols. The issue with this array of protocols is that each protocol is tuned to a specific application. For example, Wi-Fi™ may be particularly useful for high bandwidth data applications that do not require long battery life. Zigbee™ may be particularly useful for low bandwidth data applications to maximize battery life. Additionally, not every wireless protocol is globally compliant. For example, Zwave™ may have different hardware designs for various operational regions.

Smart home systems may include a collection of different networks that operate at a common frequency suitable for home networks. For example, a Wi-Fi™ network of a smart home system, a BLUETOOTH network of the smart home system, and an IEEE 802.15.4 network of the smart home system may each operate at a 2.4 GHz frequency.

Smart home systems face numerous difficulties. Devices cannot be custom-manufactured to work optimally in a particular home due to mass production, but the variety of home layouts, network layouts, and building materials introduce the possibility of issues in incorporating the mass produced sensors and hub devices into homes. Hub factors, sensor factors, and environmental factors may all lead to issues in the local premise network, including supervision failure, battery failure, device interference, or device location issues. However, due to the uniqueness of every environment the hubs and sensors may operate in, the issues may be unknown until the point where the failures occur.

In accordance with the techniques of the disclosure, a device may receive hub data from one or more hub devices, sensor data from one or more sensor devices, and environmental data from some source device, such as the hub device or a server that stores the details of the local premise wireless network environment. The device may apply a prediction model to the hub data, the sensor data, and the environmental data to determine a prediction of supervision failure between the hub device and the at least one sensor device.

Techniques described herein may improve a performance of a network. For example, a device that performs the prediction described herein may address potential issues in a local premise network prior to the issue occurring. This may reduce the downtimes experienced when the failures ultimately occur, the time and effort to discover the failure after the occurrence of the failure, and the loss in efficiency experienced by the failures.

Furthermore, the failure experienced by sensors and hub devices in a local security network is inherent to this type of technology. Different environments may have different layouts, constructions, and network setups, meaning there may be no universal system to accurately predict or determine failures in every location. By taking environmental factors into account, the techniques described herein solve a problem inherent to this technology to adequately and accurately predict potential failures in locations that have unique factors that could possibly contribute to those failures.

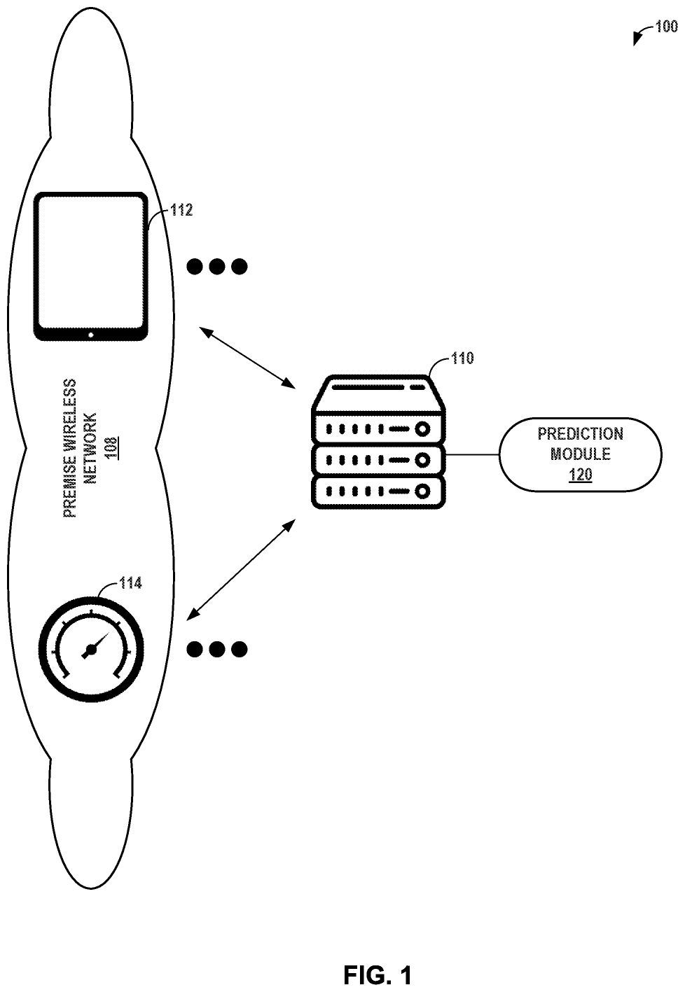

FIG. 1 is a conceptual diagram illustrating an example system for predicting a supervision failure, in accordance with some examples of this disclosure. System 100 may include a variety of devices, including computing device 110, one or more hub devices 112, and one or more sensor devices 114.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein. In many examples, computing device 110 may be one of hub devices 112 or may be a remote server device configured to communicate with hub devices 112 and sensor devices 114.

Computing device 110 may include prediction module 120. Prediction module 120 may execute locally (e.g., at processors 240) to provide functions associated with applying a prediction model to various pieces of data received by computing device 110 in order to determine a prediction of a supervision failure. In some examples, prediction module 120 may act as an interface to a remote service accessible to computing device 110. For example, prediction module 120 may be an interface or application programming interface (API) to a remote server that applies the prediction model and determines the prediction of supervision failure.

Each of hub devices 112 may be any computing device, including tablet computers or centralized panels, that are configured to coordinate the other devices in system 100. For instance, one of hub devices 112 may receive user input to control some aspect of one or more of the sensor devices 114. Hub devices 112 may also relay audio or visual output from sensor devices 114, or indications of failure determined by computing device 110, to the user in order to provide feedback regarding the system, such as alarm events or status updates.

Sensor devices 114 may include any sensors that could be placed in a smart home system, including thermostats, indoor motion sensors, outdoor motion sensors, door and window contact sensors, air vent dampers, smart doorbells, outdoor air sensors, outdoor infrared sensors, indoor infrared sensors, routers, mobile devices, a security device, a water heater, a water flow controller, a garage door controller, a motion passive infrared (PIR) sensor, a mini contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, and a keypad, among other things.

Premise wireless network may include hub devices 112 and sensors 114. In some instances, premise wireless network 108 may also include computing device 110. In other instances, premise wireless network 108 may be configured to communicate with computing device 110, which is located on a separate network. Premise wireless network may be any piece of infrastructure that facilitates communication between devices, including WiFi®, BLUETOOTH, Zigbee®, or any other wireless or wired communication technology. In some instances, premise wireless network 108 and one or more devices on premise wireless network 108 may be configured to communicate using a time division multiple access (TDMA) protocol.

In accordance with the techniques described herein, computing device 110 may receive, from hub device 112 of premise wireless network 108, hub wireless communication data. Computing device 110 may also receive, from at least one sensor device of sensor devices 114 of premise wireless network 108 and in wireless communication via premise wireless network 108 with hub devices 112, sensor wireless communication data. Computing device 110 may also receive environmental data, either from one of hub devices 112, from a database, stored either locally or remotely, that includes the environmental data for a building that contains premise wireless network 108, or some other computing device. Prediction module 120 may apply a prediction model to the hub wireless communication data, the sensor wireless communication data, and the environmental data to determine a prediction of supervision failure between hub devices 112 and the at least one sensor device of sensor devices 114.

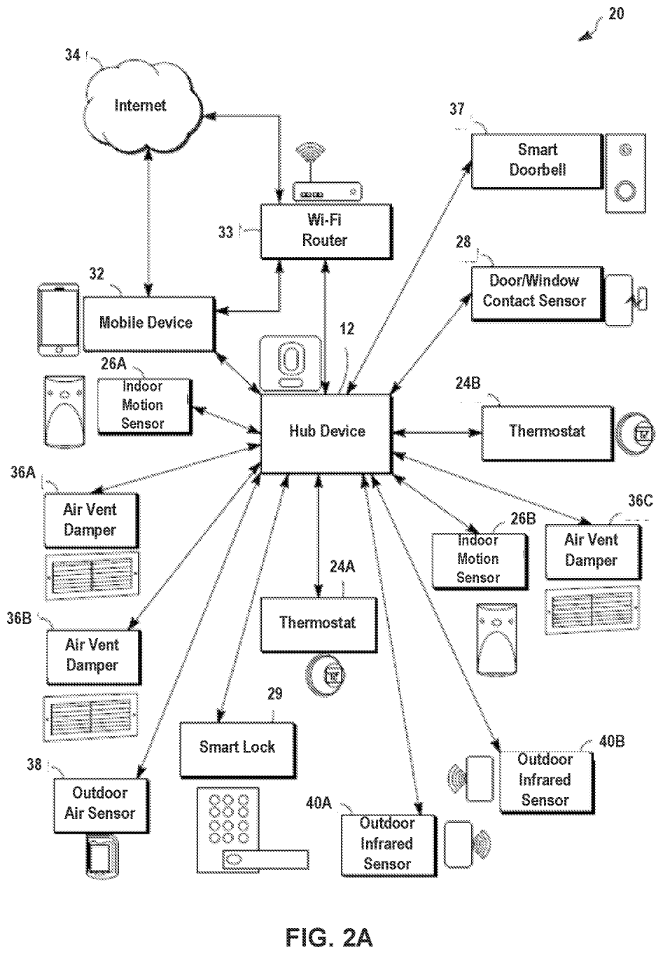

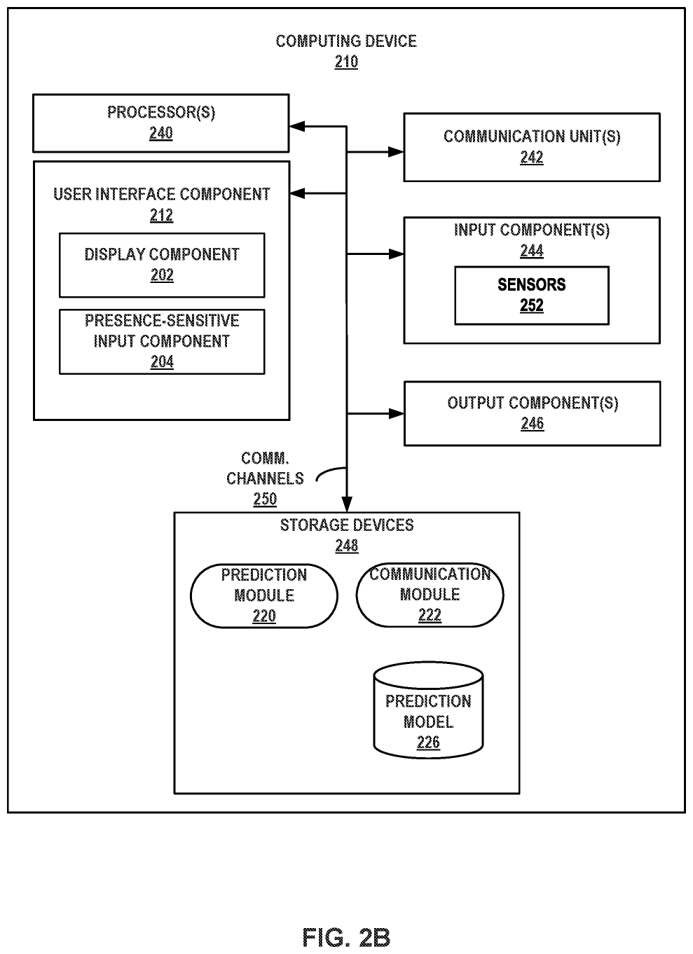

FIG. 2A is a conceptual block diagram illustrating a networked system 20, which may be one example of the networked system 10 of FIG. 1, in accordance with some examples of this disclosure. System 20 includes hub device 12, thermostat 24A, thermostat 24B (collectively, thermostats 24), indoor motion sensor 26A, outdoor motion sensor 26B (collectively, motion sensors 26), door/window contact sensor 28, air vent damper 36A, 36B, 36C (collectively, air vent dampers 36), smart doorbell 37, outdoor air sensor 38, outdoor infrared sensor 40A, indoor infrared sensor 40B (collectively, infrared sensors 40), router 33, and mobile device 32. Hub device 12 and one or more of the devices in the networked system 20 can communicate using a first frequency band (e.g., 2.4 GHZ) and/or a second, different frequency band (e.g., sub 1 GHz). For example, at least one device in the networked system 20 can communicate with hub device 12 using the first frequency band while at least one other device in the networked system 20 can communicate with hub device 12 using the second, different frequency band. In another example, at least one device in the networked system 20 can selectively communication with hub device 12 using one of the first frequency band and the second, different frequency band as selected for a specific superframe. While hub device 12 is shown as a distinct component, hub device 12 may be integrated into one or more of thermostats 24, motion sensors 26, door/window contact sensor 28, air vent dampers 36, smart doorbell 37, outdoor air sensor 38, and infrared sensors 40. The various devices of system 20 are for example purposes only. For example, additional devices may be added to system 20 and/or one or more devices of system 20 may be omitted.

The system 20 is a non-limiting example of the techniques of this disclosure. Other example systems may include more, fewer, or different components and/or devices. While FIG. 2A illustrates a mobile phone, mobile device 32 may, in some examples, include a tablet computer, a laptop or personal computer, a smart watch, a wireless network-enabled key fob, an e-readers, or another mobile device. Mobile device 32 and/or router 33 may be connected to a wide area network, such as, for example, internet 34. Internet 34 may represent a connection to the Internet via any suitable interface, such as, for example, a digital subscriber line (DSL), dial-up access, cable internet access, fiber-optic access, wireless broadband access, hybrid access networks, or other interfaces. Examples of wireless broadband access may include, for example, satellite access, WiMax™, cellular (e.g., 1X, 2G, 3G™, 4G™, 5G™, etc.), or another wireless broadband access.

Central hub device 12 may be in wireless data communication with thermostats 24, motion sensors 26, door/window contact sensor 28, air vent dampers 36, smart doorbell 37, outdoor air sensor 38, and infrared sensors 40. For example, thermostats 24, motion sensors 26, door/window contact sensor 28, air vent dampers 36, smart doorbell 37, outdoor air sensor 38, and infrared sensors 40 may be directly connected to hub device 12 using one or more wireless channels according to a connection protocol, such as, but not limited to, for example, IEEE 802.15.4, BLUETOOTH, or another connection protocol.

Each of thermostats 24, motion sensors 26, door/window contact sensor 28, air vent dampers 36, smart doorbell 37, outdoor air sensor 38, and infrared sensors 40 may include either a sensor device (e.g., a device configured to collect and/or generate sensor data), a controllable device, or both, as described herein. For example, thermostats 24 may include comfort devices having sensors, such as a thermometer configured to measure an air temperature. In some examples, air vent dampers 36 may include devices located within an air vent or air duct, configured to either open or close the shutters of an air vent in response to receiving instructions from hub device 12.

Although not shown in the example of FIG. 2A, central hub device 12 may be in indirect wireless data communication (e.g., communication via a repeater node) with one or more of thermostats 24, motion sensors 26, door/window contact sensor 28, air vent dampers 36, smart doorbell 37, outdoor air sensor 38, and infrared sensors 40. For example, outdoor air sensor 38 may be indirectly connected thermostat to hub device 12 using a wireless channel according to a connection protocol, such as, but not limited to, for example, IEEE 802.15.4, BLUETOOTH, or another connection protocol. For instance, outdoor air sensor 38 may be connected to hub device 12 via thermostat 24A, outdoor infrared sensor 40A may be connected to hub device 12 via outdoor motion sensor 26B, etc.

Thermostats 24 may be configured to wirelessly transmit the temperature (e.g., sensor data) directly to hub device 12. Additionally, thermostats 24 may include controllable devices, in that they may activate or deactivate a heating, cooling, or ventilation system in response to receiving instructions from hub device 12. For example, thermostat 24A may collect temperature data and transmit the data to hub device 12. Hub device 12, in response to receiving the temperature data, may determine that a respective room is either too hot or too cold based on the temperature data, and transmit a command to thermostat 24A to activate a heating or cooling system as appropriate. In this example, each of thermostats 24 may include both sensor devices and controllable devices within a single distinct unit.

Indoor and outdoor motion sensors 26 may include security devices configured to detect the presence of a nearby mobile object based on detecting a signal, such as an electromagnetic signal, an acoustic signal, a magnetic signal, a vibration, or other signal. The detected signal may or may not be a reflection of a signal transmitted by the same device. In response to detecting the respective signal, motion sensors 26 may generate sensor data indicating the presence of an object, and wirelessly transmit the sensor data to hub device 12. Hub device 12 may be configured to perform an action in response to receiving the sensor data, such as outputting an alert, such as a notification to mobile device 32, or by outputting a command for the respective motion sensor 26 to output an audible or visual alert. In this example, each of motion sensors 26 may include both sensor devices and controllable devices within a single unit.

Door and/or window contact sensor 28 may include a security device configured to detect the opening of a door or window on which the door and/or window contact sensor 28 is installed. For example, contact sensor 28 may include a first component installed on a door or window; and a second component installed on a frame of the respective door or window. When the first component moves toward, past, or away from the second component, the contact sensor 28 may be configured to generate sensor data indicating the motion of the door or window, and wirelessly transmit the sensor data to hub device 12. In response to receiving the sensor data, hub device may be configured to perform an action such as outputting an alert, such as a notification to mobile device 32, or by outputting a command for the respective contact sensor 28 to output an audible or visual alert. In this example, contact sensor 28 may include a sensor devices and a controllable devices within a single unit.

Air vent dampers 36 may be configured to regulate a flow of air inside of a duct. For example, thermostats 24 may generate a control signal to close air vent damper 36A (e.g., when the room is not occupied). In this example, in response to the control signal, air vent damper 36 may close to prevent air from flowing from air vent damper 36A. In some examples, air vent dampers 36 may send sensor data indicating a state (e.g., open or closed) of the respective air vent damper. For instance, air vent damper 36 may output, to thermostats 24 an indication that air vent damper 36 is in an open state.

Smart doorbell 37 may be configured to provide notifications to hub device 12. For example, smart doorbell 37 may be configured to provide a notification (e.g., message) when a button (e.g., doorbell) of smart doorbell 37 is activated. In some examples, smart doorbell 37 may include motion sensor circuitry configured to generate a notification in response to motion detected near smart doorbell 37. In some examples, smart doorbell 37 may be configured to generate video content in response to motion detected near smart doorbell 37. In some examples, smart doorbell 37 may be configured to generate audio content in response to motion detected near smart doorbell 37. For instance, in response to motion detected near smart doorbell 37, smart doorbell 37 may generate video content using a camera and/or audio content using a microphone. In this instance, smart doorbell 37 may output the video content and audio content to hub device 12, which may forward the video content and/or audio content to mobile device 32.

Outdoor air sensor 38 may be configured to generate sensor data indicating, for example, a temperature, humidity, and/or quality (e.g., carbon monoxide, particulate matter, or other hazards) of the surrounding air. In some examples, outdoor air sensor 38 may wireless transmit the sensor data to hub device 12. For instance, outdoor air sensor 38 may periodically output a current or average temperature to thermostats 24 via hub device 12.

Outdoor passive infrared sensors 40 may include security devices configured to detect the presence of a nearby object, such as a person, based on detecting infrared wavelength electromagnetic waves emitted by the object. In response to detecting the infrared waves, passive infrared sensors 40 may generate sensor data indicating the presence of the object, and wirelessly transmit the sensor data to hub device 12. Hub device 12 may be configured to perform an action in response to receiving the sensor data, such as outputting an alert, such as a notification to mobile device 32, or by outputting a command for the respective passive infrared sensor 40 to output an audible or visual alert.

System 20 may include various devices, including, for example, a security device, a water heater, a water flow controller, a garage door controller, or other devices. For example, system 20 may include one or more of: a door contact sensor, a motion passive infrared (PIR) sensor, a mini contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, a keypad, and/or other devices.

In accordance with the techniques of the disclosure, a device, such as central hub device 12 or a remote device not pictured, may receive hub data from central hub device 12. The device may also receive sensor data from one or more of thermostats 24, motion sensors 26, door/window contact sensor 28, air vent dampers 36, smart doorbell 37, outdoor air sensor 38, and infrared sensors 40. The device may also receive environmental data from some source device, such as central hub device 12 or some other device or database that stores the details of the local premise wireless network environment. The device may apply a prediction model to the hub data, the sensor data, and the environmental data to determine a prediction of supervision failure between the hub device and the at least one sensor device.

Techniques described herein may improve a performance of a network. For example, the device that performs the prediction described herein may address potential issues in a local premise network prior to the issue occurring. This may reduce the downtimes experienced when the failures ultimately occur, the time and effort to discover the failure after the occurrence of the failure, and the loss in efficiency experienced by the failures.

Furthermore, the failure experienced by any of thermostats 24, motion sensors 26, door/window contact sensor 28, air vent dampers 36, smart doorbell 37, outdoor air sensor 38, and infrared sensors 40, as well as central hub device 12 in a local security network is inherent to this type of technology. Different environments may have different layouts, constructions, and network setups, meaning there may be no universal system to accurately predict or determine failures in every location. By taking environmental factors into account, the techniques described herein solve a problem inherent to this technology to adequately and accurately predict potential failures in locations that have unique factors that could possibly contribute to those failures.

FIG. 2B is a block diagram illustrating an example computing device configured to predict whether one or more sensor devices or hub devices in a local premise network are experiencing, or are likely to experience, a supervision failure, in accordance with one or more aspects of the techniques described in this disclosure. Computing device 210 of FIG. 2B is described below as an example of computing device 110 of FIG. 1. FIG. 2B illustrates only one particular example of computing device 210, and many other examples of computing device 210 may be used in other instances and may include a subset of the components included in example computing device 210 or may include additional components not shown in FIG. 2B.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2B, computing device 210 includes user interface component (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include prediction module 220, communication module 222, and prediction model 226.

One or more processors 240 may implement functionality and/or execute instructions associated with computing device 210 to apply prediction model 226 to received data in order to determine a prediction of supervision failure. That is, processors 240 may implement functionality and/or execute instructions associated with computing device 210 to receive various pieces of data from different sources and apply prediction model 226 to that data to predict whether supervision failure has or is likely to occur on those sources.

Examples of processors 240 include application processors, display controllers, auxiliary processors, one or more sensor hubs, and any other hardware configure to function as a processor, a processing unit, or a processing device. Modules 218, 220, 222, and 224 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to apply prediction model 226 to received data in order to determine a prediction of supervision failure.

Prediction module 220 may execute locally (e.g., at processors 240) to provide functions associated with forming the prediction of supervision failure. In some examples, prediction module 220 may act as an interface to a remote service accessible to computing device 210. For example, prediction module 220 may be an interface or application programming interface (API) to a remote server that applies prediction model 226 to received data in order to determine a prediction of supervision failure.

In some examples, communication module 222 may execute locally (e.g., at processors 240) to provide functions associated with communicating with outside devices. In some examples, communication module 222 may act as an interface to a remote service accessible to computing device 210. For example, communication module 222 may be an interface or application programming interface (API) to a remote server that analyzes receives the data used by prediction module 220 to determine the prediction of supervision failure.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222, and prediction model 226. Storage components 248 may include a memory configured to store data or other information associated with modules 220 and 222, and prediction model 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras) one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the display's or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 222 receives, from a hub device of a premise wireless network (e.g., a TDMA-enabled wireless network or a non-TDMA wireless network), hub wireless communication data. In some examples, the hub wireless communication data includes a collection of one or more of an operating channel number of the hub device, an information channel number of the hub device, a date of installation of the hub device, a media access control (MAC) address of the hub device, and a short address of the hub device. In some instances, such as instances where the premise wireless network is a TDMA-enabled wireless network, the hub wireless communication data can include, either additionally or alternatively, a number of frequency agility for the hub device, a number of packets received by the hub device and from the at least one sensor device, a supervision time of the hub device, a wake-up time of the hub device, a number of over the air network downloads (“OND”) on the at least one sensor device, a supervision loss of the hub device, a superframe slotting of the hub device, and an energy on each channel used by the hub device. As one example, a number of over the air network downloads (“OND”) can refer to firmware, or software, received at the at least one sensor device, for instance wirelessly over the network (e.g., wirelessly over the network from the hub device), and downloaded at the at least one sensor device. One such OND can be a firmware or software update remotely received, and downloaded, at the at least one sensor device. Frequency agility means when an operating channel number gets jammed and the hub device has to change operating channel numbers. Therefore, a number of frequency agility is a number of times the hub device changes the operating channel number (e.g., from channel 1 to channel 11), with a higher number indicating a higher likelihood of future supervision failure.

Communication module 222 further receives, from at least one sensor device of the premise wireless network and in wireless communication via the premise wireless network with the hub device, sensor wireless communication data. In some examples, the sensor wireless communication data includes a collection of one or more of a battery status of the at least one sensor device, an estimated battery life of the at least one sensor device, a type of battery in the at least one sensor device, and a theoretical battery life estimation for the at least one sensor device. In some instances, such as instances where the premise wireless network is a TDMA-enabled wireless network, the sensor wireless communication data can include, either additionally or alternatively, one or more of a number of non-time division multiple access (TDMA) protocol packets, a link quality indication (LQI) signal strength, a number of beacon loss, a number of sync loss, a number of sync commands, and energy detection around the at least one sensor device.

Communication module 222 further receives environmental data. In some examples, the environmental data can include a collection of one or more of wireless operating channel power data, a number of additional hub devices in the premise wireless network, an operating channel for each of the additional hub devices, a number of sensor devices in the at least one sensor device on the premise wireless network, a location of the at least one sensor device, an image of an environment including the hub device and the at least one sensor device, a size of a building that contains the premise wireless network, a material of one or more walls in the building, a layout plan of the building, a location of an access point for the premise wireless network, and a region of operation. In some instances, such as instances where the premise wireless network is a TDMA-enabled wireless network, the environmental data can include, either additionally or alternatively, one or more of a first WiFi® operating channel power at the hub device, and a second WiFi® operating channel power around the hub device.

Prediction module 220 applies prediction model 226 to the hub wireless communication data, the sensor wireless communication data, and the environmental data to determine a prediction of supervision failure between the hub device and the at least one sensor device. In some instances, computing device 210 may be a server device that applies prediction model 226 to the hub wireless communication data, the sensor wireless communication data, and the environmental data to determine the prediction of supervision failure between the hub device and the at least one sensor device. In other instances, computing device 210 may be the hub device itself that applies prediction model 226 to the hub wireless communication data, the sensor wireless communication data, and the environmental data to determine the prediction of supervision failure between the hub device and the at least one sensor device. Communication module 222 may output an indication of the prediction of supervision failure, such as producing an audio or visual alert to be output on the hub device or some other mobile device or computing device owned or operated by a user that controls the hub device.

Prediction module 220 may utilize the received environmental data to alter prediction model 226, either prior to or after the determination of the prediction of supervision failure. In other words, prediction module 220 may adjust prediction model 226 based at least in part on the environmental data. In adjusting the prediction model based at least in part on the environmental data, prediction module 220 may analyze one or more of a size of a building that contains the premise wireless network, a material of one or more walls in the building, a location of the at least one sensor device, a location of the hub device, a layout plan of the building, and a location of an access point for the premise wireless network to determine an environmental impact of the environmental data. Prediction module 220 may then adjust one or more aspects of the prediction model based on the environmental impact.

For instance, prediction model 226 may be a series of weights applied to various pieces of data received by communication module 222. After applying the weights, prediction module 220 may determine a sum of those values and compare the values to a threshold. If the threshold is exceeded, then prediction module 220 may predict a supervision failure. Conversely, if the threshold is not exceeded, then prediction module 220 may predict no supervision failure.

If the building is an open complex without walls separating different parts of the building, supervision failures may be less likely than normal given the lack of obstacles. As such, prediction module 220 may decrease the weights in prediction model 226 and/or increase the thresholds in prediction model 226 in order to make it less likely that a supervision failure is predicted. Conversely, if there are a number of walls separating areas in the building, supervision failures may be more likely and prediction module 220 may increase the weights in prediction model 226 and/or decrease the thresholds in prediction model 226 in order to make it more likely that a supervision failure is predicted. Similarly, if the walls of the building are made of wood, it may be less likely that the system will experience a supervision failure as compared to walls made of steel or concrete. Prediction module 220 may adjust prediction model 226 accordingly.

In some examples, after determining the prediction of the supervision failure, prediction module 220 may detect whether the supervision failure actually occurred. Prediction module 220 may further adjust one or more aspects of prediction model 226 based on the prediction of the supervision failure and whether the supervision failure actually occurred. For instance, if prediction module 220 predicts supervision failure but no supervision failure actually occurs, prediction module 220 may adjust one or more weights in prediction model 226 (e.g., decreasing the weights for a false positive) and/or adjust one or more thresholds in prediction model (e.g., increasing the thresholds for a false positive). Prediction module 220 may adjust one or more of the weights and thresholds in an opposite manner if prediction module fails to predict a supervision failure that actually occurs.

In some instances, prediction model 226 may be a complex model that includes multiple sub-models, such as an environmental model, a sensor model, a hub model, a system model, and a final model. In applying prediction model 226, prediction module 220 may apply the environmental model to the environmental data, such as hub device input and environmental data analysis, to determine an environment state. Prediction module 220 may similarly apply the hub model to the hub wireless communication data to determine a hub state and apply the sensor model to the sensor wireless communication data to determine a sensor state. Once these three individual states are determined in some order, prediction module 220 may then apply the system model to the environment state, the hub state, and the sensor state, as well as any pertinent environmental data that may adjust certain weights or thresholds, to determine a system state. Prediction module 220 may then, in some instances, apply the final model to the system state, as well as any critical parameters, to predict the supervision failure.

In accordance with the techniques of this disclosure, a supervision failure could be any one or more of a supervision loss (e.g., an instance where the hub device does not receive a “check-in” type signal from a sensor device), a battery replacement (e.g., a low battery at the sensor device), a local interference source, an interference presence around the at least one sensor device, a sensor installation location problem, a repeater installation location problem, and a sensor location change. For each one of these potential failures, certain parameters may be more critical for the determination of that failure.

For instance, when the supervision failure is a supervision loss, parameters including various subsets of the frequency agility number, the number of packets received by the hub device and from sensor devices, a supervision time of the hub device, a wake-up time of the hub device, a number of over the air network downloads (“OND”) on the at least one sensor device, a supervision loss of the hub device, a superframe slotting of the hub device, an energy on each channel used by the hub device, a number of non-time division multiple access (TDMA) protocol packets, a link quality indication (LQI) signal strength, a number of beacon loss, a number of sync loss, a number of sync commands, energy detection around the at least one sensor device, a first WiFi® operating channel power at the hub device, and a second WiFi® operating channel power around the hub device may be better at predicting supervision loss than a date of installation, for instance. For battery failures, prediction module 220 and prediction model 226 may more strongly consider parameters such as a number of non-TDMA packets seen in the premise wireless network, a number of beacons lost by the sensor devices, a number of sync loss by the sensor devices, a number of sync command, and an energy detection around the sensor devices. For interference failures, prediction module 220 and prediction model 226 may more strongly consider parameters such as a number of non-TDMA packets seen in the premise wireless network, a number of beacons lost by the sensor devices, a number of sync loss by the sensor devices, a number of sync command, and an energy detection around the sensor devices. For location issues, prediction module 220 and prediction model 226 may more strongly consider parameters such as an LQI signal strength, an energy detection around the sensors, a WiFi® operating channel and its power at the hub device, a WiFi® operating channel and its power around the hub device, an operating channel number for the hub device, an information channel number for the hub device, a home or building layout plan, and a region of operation (e.g., the United States, Europe, Japan, China, etc.).

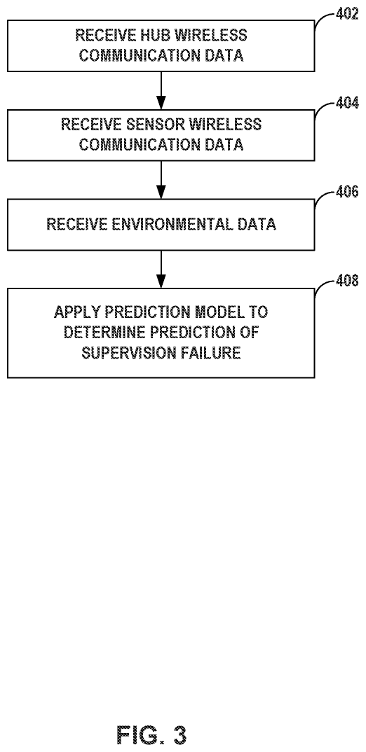

FIG. 3 is a flow chart illustrating an example mode of operation. The techniques of FIG. 3 may be performed by one or more processors of a computing device, such as computing device 110 of FIG. 1 and/or computing device 210 illustrated in FIG. 2. For purposes of illustration only, the techniques of FIG. 3 are described within the context of computing device 210 of FIG. 2, although computing devices having configurations different than that of computing device 210 may perform the techniques of FIG. 3.

In accordance with the techniques of this disclosure, communication module 222 receives, from a hub device of a premise wireless network, hub wireless communication data (302). Communication module 222 further receives, from at least one sensor device of the premise wireless network and in wireless communication via the premise wireless network with the hub device, sensor wireless communication data (304). Communication module 222 also receives environmental data (306). Prediction module 220 applies a prediction model to the hub wireless communication data, the sensor wireless communication data, and the environmental data to determine a prediction of supervision failure between the hub device and the at least one sensor device (308).

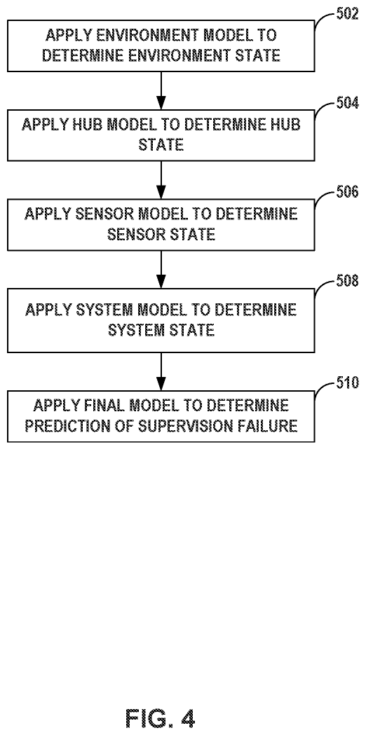

FIG. 4 is a flow chart illustrating an example mode of operation. The techniques of FIG. 4 may be performed by one or more processors of a computing device, such as computing device 110 of FIG. 1 and/or computing device 210 illustrated in FIG. 2. For purposes of illustration only, the techniques of FIG. 4 are described within the context of computing device 210 of FIG. 2, although computing devices having configurations different than that of computing device 210 may perform the techniques of FIG. 4.

In applying the prediction model, prediction module 220 may apply the environmental model to the environmental data to determine an environment state (402). Prediction module 220 may further apply the hub model to the hub wireless communication data to determine a hub state (404). Prediction module 220 may also apply the sensor model to the sensor wireless communication data to determine a sensor state (406). Prediction module 220 may further apply the system model to the environment state, the hub state, and the sensor state to determine a system state (408). Prediction module 220 may then apply the final model to the system state to predict the supervision failure (410).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising the steps of:
receiving, from a hub device of a premise wireless network, hub wireless communication data;
receiving, from at least one sensor device of the premise wireless network and in wireless communication via the premise wireless network with the hub device, sensor wireless communication data;
receiving environmental data; and
applying a prediction model to the hub wireless communication data, the sensor wireless communication data, and the environmental data to determine a prediction of supervision failure between the hub device and the at least one sensor device.

2. The method of claim 1, wherein the hub wireless communication data comprises a collection of one or more of:
an operating channel number,
an information channel number,
a date of installation,
a media access control (MAC) address, and
a short address.

3. The method of claim 2, wherein the collection further comprises one or more of:
a number of frequency agility,
a number of packets received from the at least one sensor device,
a supervision time of the hub device,
a wake-up time of the hub device,
a number of over the air network downloads on the at least one sensor device,
a supervision loss,
a superframe slotting, and
an energy on each channel used by the hub device.

4. The method of claim 1, wherein the sensor wireless communication data comprises a collection of one or more of:
a battery status of the at least one sensor device,
an estimated battery life of the at least one sensor device,
a type of battery in the at least one sensor device, and
a theoretical battery life estimation for the at least one sensor device.

5. The method of claim 4, wherein the collection further comprises one or more of:
a number of non-time division multiple access (TDMA) protocol packets,
a link quality indication (LQI) signal strength,
a number of beacon loss,
a number of sync loss,
a number of sync commands, and
energy detection around the at least one sensor device.

6. The method of claim 1, wherein the environmental data comprises a collection of one or more of:
wireless operating channel power data,
a number of additional hub devices,
an operating channel for each of the additional hub devices,
a number of sensor devices in the at least one sensor device,
a location of the at least one sensor device,
an image of an environment including the hub device and the at least one sensor device,
a size of a building that contains the premise wireless network,
a material of one or more walls in the building,
a layout plan of the building,
a location of an access point for the premise wireless network, and
a region of operation.

7. The method of claim 6, wherein the collection further comprises one or more of:
a first WiFi® operating channel power at the hub device, and
a second WiFi® operating channel power around the hub device.

8. The method of claim 1, further comprising:
adjusting the prediction model based at least in part on the environmental data.

9. The method of claim 8, wherein adjusting the prediction model based at least in part on the environmental data comprises:
analyzing one or more of a size of a building that contains the premise wireless network, a material of one or more walls in the building, a location of the at least one sensor device, a location of the hub device, a layout plan of the building, and a location of an access point for the premise wireless network to determine an environmental impact of the environmental data;
adjusting one or more aspects of the prediction model based on the environmental impact.

10. The method of claim 1, further comprising:
after determining the prediction of the supervision failure, detecting whether the supervision failure actually occurred; and
adjusting one or more aspects of the prediction model based on the prediction of the supervision failure and whether the supervision failure actually occurred.

11. The method of claim 10, wherein adjusting one or more aspects of the prediction model comprises one or more of adjusting one or more weights in the prediction model and adjusting one or more thresholds in the prediction model.

12. The method of claim 1, wherein the prediction model comprises each of an environmental model, a sensor model, a hub model, a system model, and a final model.

13. The method of claim 12, wherein applying the prediction model comprises:
applying the environmental model to the environmental data to determine an environment state;
applying the hub model to the hub wireless communication data to determine a hub state;
applying the sensor model to the sensor wireless communication data to determine a sensor state;
applying the system model to the environment state, the hub state, and the sensor state to determine a system state; and
applying the final model to the system state to predict the supervision failure.

14. The method of claim 1, wherein the supervision failure comprises one or more of:
a supervision loss,
a battery replacement,
a local interference source,
an interference presence around the at least one sensor device,
a sensor installation location problem,
a repeater installation location problem, and
a sensor location change.

15. The method of claim 1, wherein applying the prediction model comprises applying, by a server device, the prediction model to the hub wireless communication data, the sensor wireless communication data, and the environmental data to determine the prediction of supervision failure between the hub device and the at least one sensor device.

16. The method of claim 1, wherein applying the prediction model comprises applying, by the hub device, the prediction model to the hub wireless communication data, the sensor wireless communication data, and the environmental data to determine the prediction of supervision failure between the hub device and the at least one sensor device.

17. The method of claim 1, wherein the premise wireless network comprises a time division multiple access (TDMA) protocol-enabled wireless network.

18. A device comprising:
a storage component configured to store a prediction model;
one or more communication units configured to:
receive, from a hub device of a premise wireless network, hub wireless communication data;
receive, from at least one sensor device of the premise wireless network and in wireless communication via the premise wireless network with the hub device, sensor wireless communication data; and
receive environmental data; and
one or more processors configured to:
apply the prediction model to the hub wireless communication data, the sensor wireless communication data, and the environmental data to determine a prediction of supervision failure between the hub device and the at least one sensor device.

19. The device of claim 18, wherein the hub wireless communication data comprises a collection of one or more of:
a number of frequency agility,
a number of packets received from the at least one sensor device,
a supervision time of the hub device,
a wake-up time of the hub device,
a number of over the air network downloads on the at least one sensor device,
a supervision loss,
a superframe slotting, and
an energy on each channel used by the hub device.

20. The device of claim 18, wherein the sensor wireless communication data comprises a collection of one or more of:
a number of non-time division multiple access (TDMA) protocol packets,
a link quality indication (LQI) signal strength,
a number of beacon loss,
a number of sync loss,
a number of sync commands, and
energy detection around the at least one sensor device.
